(19) United States
(12) Patent Application Publication
(10) Pub. No.: US 2026/0301183 A1
(43) Pub. Date: Oct. 1, 2026

(54) METHOD FOR PROCESSING MEDICAL IMAGE AND MEDICAL IMAGING SYSTEM

(71) Applicant: GE Precision Healthcare LLC, Waukesha, WI (US)

(72) Inventors: Hongjian Jiang, Wuxi (CN); Olivier Gerard, Oslo (NO)

(21) Appl. No.: 19/633,643

(22) Filed: Mar. 30, 2026

(30) Foreign Application Priority Data
Mar. 31, 2025 (CN) 202510399737.3

(51) Int. Cl. G06T 7/00; G06T 5/50; G06T 5/60; G06T 7/246

(52) U.S. Cl. CPC G06T 7/0016; G06T 5/50; G06T 5/60; G06T 7/246; G06T 2200/24; G06T 2207/10132; G06T 2207/20081; G06T 2207/30048; G06T 2207/30056; G06T 2207/30104; G06T 2207/30204

(57) ABSTRACT

A method for processing a medical image including: processing a medical image using an image processing model to obtain an output; correcting the output based on a user input to obtain a correction result; determining an output deviation based on the output and the correction result; and processing a subsequent medical image based on the image processing model and the output deviation.

### CROSS-REFERENCE TO RELATED APPLICATION

This application claims priority to Chinese Patent Application No. 202510399737.3, which was file on Mar. 31, 2025 at the Chinese Patent Office. The entire contents of the above-listed application are incorporated by reference herein in their entirety.

### TECHNICAL FIELD

The present disclosure relates to the field of medical imaging, and more specifically, to a method for processing a medical image and a medical imaging system.

### BACKGROUND

In current medical imaging systems, to optimize clinical workflow, more and more image processing algorithms are introduced to enable automated operations (for example, ROI positioning for CF/Doppler, rotation and slicing of 4D volume, and the like).

However, existing medical imaging systems usually face the following problems: an image processing algorithm model can only be trained and simulated based on a single standard or operating style before leaving the factory. In addition, in clinical practice, actual scenarios of use often do not follow a uniform operating standard due to differences in recommendation of different guidelines and/or personal preferences of operators. This diversity cannot be learned by the image processing algorithm model of the medical imaging system in an in-factory training process. Because of fixed factory settings, an automation algorithm can only simulate an operation conforming to a single standard, which necessitates users who follow other standards to make manual correction frequently, and thus seriously affects user experience and operation efficiency.

Therefore, there is a need for a method capable of dynamically optimizing the output of the algorithm model to simulate user operations conforming to different standards or operating styles without updating the image processing algorithm model during its use after leaving the factory.

### SUMMARY

The objective of the present disclosure is intended to overcome the above-mentioned and/or other problems in the prior art. According to the present disclosure, a method for processing a medical image and a medical imaging system are provided, which can dynamically optimize output of a model to simulate outputs conforming to different standards and/or operating styles.

According to a first aspect of the present disclosure, a method for processing a medical image is provided. The method includes: processing a medical image using an image processing model to obtain an output; correcting the output based on a user input to obtain a correction result; determining an output deviation based on the output and the correction result; and processing a subsequent medical image based on the image processing model and the output deviation.

Optionally, the processing a subsequent medical image includes: processing the subsequent medical image using the image processing model to obtain a subsequent output; and adjusting the subsequent output based on the output deviation to obtain an adjusted output.

Optionally, the method further includes: correcting the adjusted output based on a subsequent user input to obtain a subsequent correction result; and updating the output deviation based on the subsequent output and the subsequent correction result.

Optionally, the image processing model includes a first artificial intelligence model, and model parameters of the first artificial intelligence model are set to be constant.

Optionally, the output deviation is determined based on a parameter difference between the output and the correction result, and the parameter difference is associated with the user input.

Optionally, the step of processing a medical image includes: adding an original reference mark to the medical image using the image processing model, where the output includes an output image, and the output image includes the original reference mark.

Optionally, the correction of the output based on a user input includes: obtaining a corrected reference mark based on correction to the original reference mark by the user input, where the correction result includes a corrected image, and the corrected image includes the corrected reference mark.

Optionally, the output deviation includes a difference between a parameter of the original reference mark and a parameter of the corrected reference mark.

Optionally, the processing a medical image using an image processing model to obtain an output includes: processing a plurality of medical images using the image processing model to obtain a plurality of outputs.

Optionally, the correction of the output based on a user input to obtain a correction result includes: correcting the plurality of outputs based on a plurality of user inputs to obtain a plurality of correction results.

Optionally, the determining an output deviation based on the output and the correction result includes: determining the output deviation based on the plurality of outputs and the plurality of correction results.

Optionally, the method further includes: for each of the plurality of outputs: determining a parameter difference between the output and a corresponding correction result to obtain a plurality of parameter differences; assigning a weight value to each of the plurality of parameter differences, wherein the output deviation is determined based on the plurality of parameter differences to which the weight values are assigned.

Optionally, the method further includes: removing one or more of the plurality of parameter differences based on a preset condition.

Optionally, the output deviation is determined based on the parameter differences using a second artificial intelligence model, and model parameters of the second artificial intelligence model are set to be constant.

According to a second aspect of the present disclosure, a medical imaging system is provided, including: a medical imaging device, configured to scan a subject to be examined for imaging to acquire a medical image; a user interface, configured to receive a user input; and a processor, configured to perform the method as described above.

Optionally, the medical imaging device includes an ultrasound probe.

According to a third aspect of the present disclosure, a computer-readable storage medium is provided, having a computer program stored thereon, where when the computer program is executed, the steps of the method as described above are implemented.

According to a fourth aspect of the present disclosure, a computer program product is provided, comprising instructions, where the instructions are executable by a processor, to implement the method as described above.

### BRIEF DESCRIPTION OF THE DRAWINGS

The present disclosure can be better understood by means of the description of the exemplary embodiments of the present disclosure in conjunction with the drawings, in which:

FIG. 1 shows a block diagram of an exemplary medical imaging arrangement.

FIG. 2 shows a block diagram of an exemplary ultrasound system.

FIG. 3 shows a flowchart of a method for processing a medical image according to some embodiments of the present disclosure.

FIG. 4 shows a flowchart of a method for processing a medical image according to some embodiments of the present disclosure.

FIG. 5 shows a flowchart of a method for processing a medical image according to some embodiments of the present disclosure.

FIG. 6 shows a flowchart of a method for processing a medical image according to some embodiments of the present disclosure.

FIG. 7 shows a schematic diagram of a medical imaging system 700 according to some embodiments of the present disclosure.

FIG. 8 shows an exemplary scenario of use of medical image processing.

In the accompanying drawings, similar components and/or features may have the same numerical reference signs. Further, components of the same type may be distinguished by letters following the reference sign, and the letters may be used for distinguishing between similar components and/or features. If only a first numerical reference sign is used in the specification, the description is applicable to any similar component and/or feature having the same first numerical reference sign irrespective of the subscript of the letter.

### DETAILED DESCRIPTION

Specific embodiments of the present disclosure will be described below, but it should be noted that in the specific description of these embodiments, for the sake of brevity of description, it is impossible to describe all features of the actual embodiments of the present disclosure in detail in this description. It should be understood that in the actual implementation process of any embodiment, just as in the process of any one engineering project or design project, a variety of specific decisions are often made to achieve specific goals of the developer and to meet system-related or business-related constraints, which may also vary from one embodiment to another. Furthermore, it should also be understood that although efforts made in such development processes may be complex and tedious, for those of ordinary skill in the art related to the content of the present disclosure, some design, manufacture, or production changes made on the basis of the technical content disclosed in the present disclosure are only common technical means, and should not be construed as the content of the present disclosure being insufficient.

References in the specification to “an embodiment,” “embodiment,” “exemplary embodiment,” and so on indicate that the embodiment described may include a specific feature, structure, or characteristic, but the specific feature, structure, or characteristic is not necessarily included in every embodiment. Besides, such phrases do not necessarily refer to the same embodiment. Further, when a specific feature, structure, or characteristic is described in connection with an embodiment, it is believed that affecting such feature, structure, or characteristic in connection with other embodiments (whether or not explicitly described) is within the knowledge of those skilled in the art.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Unless otherwise defined, the technical or scientific terms used in the claims and the description should be as they are usually understood by those possessing ordinary skill in the technical field to which they belong. The terms “first,” “second,” and the like used in the description and claims of the patent application of the present disclosure do not denote any order, quantity, or importance, but are merely intended to distinguish between different constituents. The term such as “one” or “a/an” and similar terms do not indicate a limitation of quantity, but rather indicate the existence of at least one. The term such as “include” or “comprise” and similar terms indicate that an element or object preceding the term “include” or “comprise” encompasses elements or objects and equivalent elements thereof listed after the term “include” or “comprise”, and does not exclude other elements or objects. The term such as “connect” or “link” and similar terms are not limited to physical or mechanical connections, and are not limited to direct or indirect connections.

In addition, as used herein, the term “image” broadly refers to both a viewable image and data representing a viewable image. However, many embodiments generate (or are configured to generate) at least one visual image. In addition, as used herein, as used in the ultrasound imaging environment, the phrase “image” is used to refer to an ultrasound mode, such as a B mode (2D mode), an M mode, a three-dimensional (3D) mode, a CF mode, PW Doppler, CW Doppler, MGD, and/or a B sub-mode and/or a CF sub-mode, such as shear wave elasticity imaging (SWEI), TVI, Angio, B-flow, BMI, and BMI_Angio, and in some cases, MM, CM and TVD, where “image” and/or “plane” includes a single beam or a plurality of beams.

Furthermore, as used herein, the term “processor” or “processing unit” refers to any type of processing unit that can perform desired computations required by various embodiments, such as a single-core or multi-core CPU, accelerated processing unit (APU), graphics board, DSP, FPGA, ASIC, or a combination thereof.

It should be noted that various embodiments in which images are generated or formed described herein may include processing for forming images, which includes beamforming in some embodiments and excludes beamforming in other embodiments. For example, images may be formed without performing beamforming, such as by multiplying a matrix of demodulated data by a coefficient matrix, such that the product is an image, and where this process does not form any “beams”. Furthermore, formation of images may be performed using channel combinations (e.g., synthetic aperture techniques) potentially derived from more than one transmit event.

In various embodiments, the processing for forming images is executed in software, firmware, hardware, or a combination thereof. The processing may include the use of beamforming.

As previously mentioned, in current medical imaging systems, more and more image processing algorithms are introduced to automatically simulate operations performed by clinicians for workflow improvement. However, an image processing algorithm model can only be trained in a factory to simulate operations conforming to single standard, and users who follow other standards need to continuously make further modifications to the operations.

In consideration of a conversion operation between different standards being usually a linear transformation (for example, formats for lines, square areas, angles and the like) and anatomical similarity between human bodies, the present disclosure aims to propose a method for processing a medical image, and the method can optimize the output of the aforementioned image processing algorithm model after leaving the factory without changing or updating the image processing algorithm model itself. By recording user corrections, the medical imaging system can learn, track and analyze the corrections made by the user, and automatically add corrections when the automation function is activated the next time, mimicking user operations conforming to different standards.

Hereinafter, although the present disclosure is described with reference to ultrasound as an example, it should be understood that the present disclosure is equally applicable to various medical imaging methods or systems employing a conversion operation based on a linear transformation.

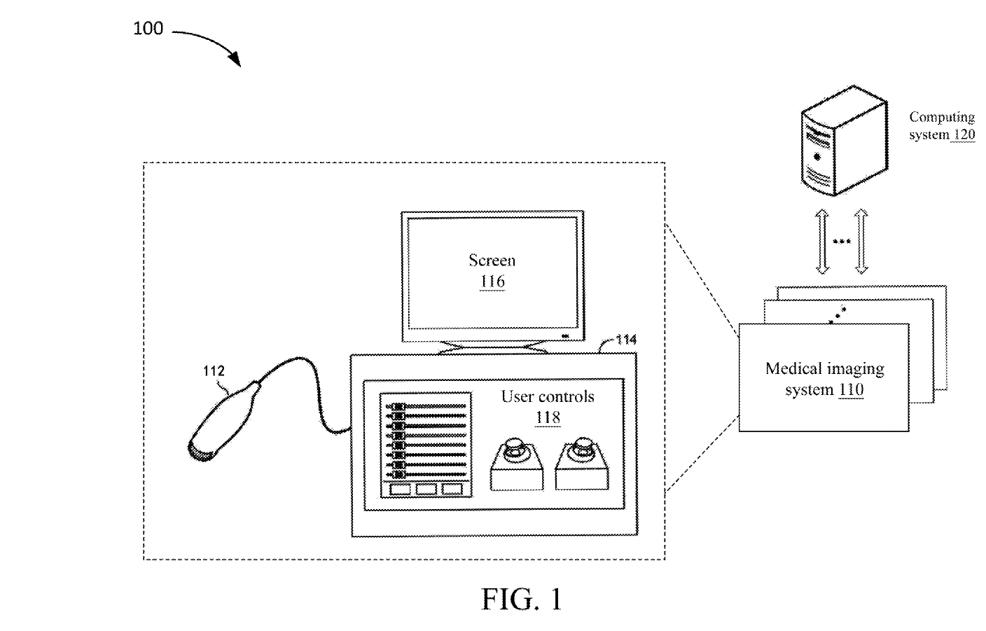

FIG. 1 shows a block diagram of an exemplary medical imaging arrangement. The exemplary medical imaging arrangement 100 may include one or more medical imaging systems 110 and one or more computing systems 120. The medical imaging arrangement 100 (including various elements) may be configured to support medical imaging and solutions associated therewith.

The medical imaging system 110 includes suitable hardware, software, or a combination thereof to support medical imaging (i.e., enabling acquisition of data for generating and/or rendering images during a medical imaging examination). An example of medical imaging may be ultrasound imaging. This may require capturing a specific type of data in a specific manner, and the data can then be used to generate data for an image. For example, the medical imaging system 110 may be an ultrasound imaging system configured to generate and/or render ultrasound images.

As shown in FIG. 1, the medical imaging system 110 may include a scanner device 112 and a display/control unit 114, and the scanner device may be portable and movable. The scanner device 112 may be configured to generate and/or capture specific types of imaging signals (and/or data corresponding thereto) by, for example, moving over a patient's body (or a portion thereof), and may include suitable circuits for performing and/or supporting such functions. The scanner device 112 may be an ultrasound probe, such as a 4D ultrasound probe. In this scenario, the scanner device 112 may emit an ultrasound signal and capture an echo ultrasound image.

The display/control unit 114 may be configured to display images (e.g., via a screen 116). In some cases, the display/control unit 114 may also be configured to at least partially generate the displayed images. In addition, the display/control unit 114 may further support user input/output. For example, in addition to images, the display/control unit 114 may further provide (e.g., via the screen 116) user feedback (e.g., information related to the system, the functions and settings thereof, etc.). The display/control unit 114 may further support user input (e.g., via user controls 118) to, for example, allow control of medical imaging. User input can involve controlling the display of images, selecting settings, specifying user preferences, requesting feedback, etc.

In some specific embodiments, the medical imaging arrangement 100 may further include additional and dedicated computing resources, such as one or more computing systems 120. In this regard, each computing system 120 may include circuits, interfaces, logic, and/or code suitable for processing, storing, and/or communicating data. The computing system 120 may be a specialized device configured for use specifically in conjunction with medical imaging, or it may be a general-purpose computing system (e.g., a personal computer, server, etc.) that is set up and/or configured to perform the operations described below with respect to computing system 120. The computing system 120 may be configured to support the operation of the medical imaging system 110, as described below. In this regard, various functions and/or operations can be offloaded from the imaging system, which may simplify and/or centralize certain aspects of processing to reduce costs, for example, by eliminating the need to add processing resources to the imaging system.

The computing system 120 may be set up and/or arranged for use in different ways. For example, in some specific embodiments, a single computing system 120 may be used; and in other specific embodiments, a plurality of computing systems 120 are configured to work together (for example, configured based on distributed processing), or individually. Each of the computing systems 120 is configured to process a specific aspect and/or function, and/or to process data only for a specific medical imaging system 110. In addition, in some specific embodiments, the computing system 120 may be local (for example, co-located with one or more medical imaging systems 110, such as within the same facility and/or the same local network); and in other specific embodiments, the computing system 120 may be remote, and thus accessible only by means of a remote connection (for example, by means of the Internet or other available remote access technologies). In particular specific embodiments, the computing system 120 may be configured in a cloud-based manner and may be accessed and/or used in a substantially similar manner to accessing and using other cloud-based systems.

Once data is generated and/or configured in the computing system 120, the data can be copied and/or loaded into the medical imaging system 110. This can be done in different ways. For example, the data may be loaded via a directed connection or link between the medical imaging system 110 and the computing system 120. In this regard, communication between the different elements of the medical imaging arrangement 100 can be performed using available wired and/or wireless connections, and/or according to any suitable communication (and/or networking) standards or protocols. Alternatively or additionally, the data may be indirectly loaded into the medical imaging system 110. For example, the data may be stored in a suitable machine-readable medium (for example, a flash memory card) and then loaded into the medical imaging system 110 using the machine-readable medium (on-site, for example, by a user of the system (such as an imaging clinician) or authorized personnel); alternatively, the data may be downloaded to a locally communicative electronic device (for example, a laptop) and then the electronic device used on-site (for example, by a user of the system or authorized personnel) to upload the data to the medical imaging system 110 by means of a direct connection (for example, a USB connector).

In operation, the medical imaging system 110 may be used to generate and present (for example, render or display) images during a medical examination, and/or used in conjunction therewith to support user input/output. The images can be 2D, 3D, and/or 4D images. The particular operations or functions performed in the medical imaging system 110 to facilitate the generation and/or presentation of images depend on the type of system (for example, the means used to obtain and/or generate the data corresponding to the images). For example, in ultrasound imaging, the data is based on the emitted and echo ultrasound signals.

In various specific embodiments according to the present disclosure, the medical imaging system and/or architecture (e.g., the medical imaging system 110 and/or the medical imaging apparatus 100 on the whole) may be configured to support a medical imaging probe being implemented and utilized.

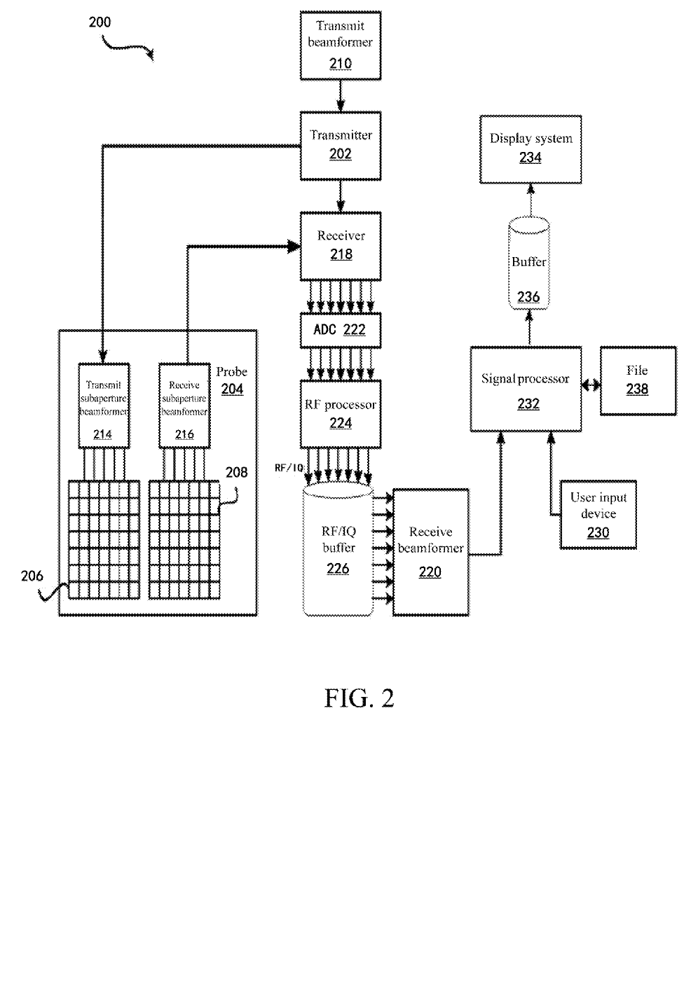

FIG. 2 shows a block diagram of an exemplary ultrasound system 200. The ultrasound system 200 includes a transmitter 202, an ultrasound probe 204, a transmit beamformer 210, a receiver 218, a receive beamformer 220, an A/D converter 222, an RF processor 224, an RF/IQ buffer 226, a user input device 230, a signal processor 232, an image buffer 236, a display system 234, and a file 238.

The transmitter 202 may include suitable logic, circuitry, interfaces and/or codes, which may be operated to drive the ultrasound probe 204. The ultrasound probe 204 may be, for example, an E4D probe (electronic 4D probe) or a mechanical rotating probe. The E4D probe may be a linear E4D probe, a curved E4D probe, or a sector E4D probe. The mechanical rotating probe may be a linear mechanical rotating probe, a curved mechanical rotating probe, or a sector mechanical rotating probe. The ultrasound probe 204 may be configured to acquire both 2D B-mode data and 2D color blood flow data, or to acquire both 2D B-mode data and another ultrasound mode that detects a blood flow velocity in the direction of the vascular axis. The ultrasound probe 204 may include a two-dimensional (2D) array of piezoelectric elements. The ultrasound probe 204 may include a set of transmit transducer elements 206 and a set of receive transducer elements 208 that typically form the same element. In some embodiments, the ultrasound probe 204 may be operated to acquire ultrasound image data covering at least most of an anatomical structure (such as a heart, a blood vessel, or any suitable anatomical structure).

The transmit beamformer 210 may include suitable logic, circuitry, interfaces, and/or code that may be operated to control the transmitter 202, and the transmitter 202 drives the set of transmitting transducer elements 206 by means of a transmit subaperture beamformer 214 to transmit ultrasound emission signals into a region of interest (e.g., a person, animal, subsurface cavity, physical structure, etc.). The emitted ultrasound signal can be backscattered from structures in the object of interest (e.g., blood cells or tissue) to produce echoes. The echo is received by the receive transducer element 208.

The set of receiving transducer elements 208 in the ultrasound probe 204 can be configured to convert the received echo to an analog signal, perform subaperture beamforming by means of a receive subaperture beamformer 216, and then transmit the analog signal to the receiver 218. The receiver 218 may include suitable logic, circuitry, interfaces, and/or code that may be operated to receive signals from the receive subaperture beamformer 216. The analog signal can be transferred to one or more of a plurality of A/D converters 222.

The plurality of A/D converters 222 may include suitable logic, circuitry, interfaces, and/or code that may be operated to convert the analog signal from the receiver 218 to a corresponding digital signal. The plurality of A/D converters 222 are disposed between the receiver 218 and the RF processor 224. Nevertheless, the present disclosure is not limited in this regard. Thus, in some embodiments, the plurality of A/D converters 222 may be integrated within the receiver 218.

The RF processor 224 may include suitable logic, circuitry, interfaces, and/or code that may be operated to demodulate the digital signals output by the plurality of A/D converters 222. According to one embodiment, the RF processor 224 may include a complex demodulator (not shown) that can be used to demodulate the digital signal to form an I/Q data pair representing the corresponding echo signal. The RF or I/Q signal data can then be transferred to the RF/IQ buffer 226. The RF/IQ buffer 226 may include suitable logic, circuitry, interfaces, and/or code that may be operated to provide temporary storage of RF or I/Q signal data generated by the RF processor 224.

The receiving beamformer 220 may include suitable logic, circuitry, interfaces, and/or code that may be operable to perform digital beamforming processing to, for example, sum and output a beam summing signal for delay-channel signals received from the RF processor 224 via the RF/IQ buffer 226. The resulting processed information may be the beam-summed signals output from the receive beamformer 220 and transmitted to the signal processor 232. According to some embodiments, the receiver 218, the plurality of A/D converters 222, the RF processor 224, and the beamformer 220 may be integrated into a single beamformer, which may be digital. In various embodiments, the ultrasound system 200 includes a plurality of receiving beamformers 220.

The user input device 230 can be used to input patient data, scan parameters and settings, select protocols and/or templates, etc. In an illustrative embodiment, the user input device 230 may be operated to configure, manage, and/or control the operation of one or more components and/or modules in the ultrasound system 200. In this regard, the user input device 230 can be used to configure, manage, and/or control the operation of the transmitter 202, the ultrasound probe 204, the transmit beamformer 210, the receiver 218, the receive beamformer 220, the RF processor 224, the RF/IQ buffer 226, the user input device 230, the signal processor 232, the image buffer 236, the display system 234, and/or the file 238. The user input devices 230 may include buttons, rotary encoders, touch screens, motion tracking, voice recognition, mouse devices, keyboards, cameras, and/or any other devices capable of receiving user instructions. In some embodiments, for example, one or more of the user input devices 230 may be integrated into other components (such as the display system 234 or the ultrasound probe 204). For example, the user input device 230 may include a touch screen display.

The signal processor 232 may include suitable logic, circuitry, interfaces, and/or code that may be operated to process the ultrasound scan data (i.e., the summed IQ signal) to generate an ultrasound image for presentation on the display system 234. The signal processor 232 may be operated to perform one or more processing operations based on a plurality of selectable ultrasound modalities on the acquired ultrasound scan data. In an illustrative embodiment, the signal processor 232 can be used to execute display processing and/or control processing, etc. As the echo signal is received, the acquired ultrasound scan data can be processed in real-time during the scan session. Additionally or alternatively, the ultrasound scan data may be temporarily stored in the RF/IQ buffer 226 during the scan session and processed in a less real-time manner during online or offline operation. In various embodiments, the processed image data may be presented at the display system 234 and/or may be stored in the file 238. The file 238 can be a local file, a picture archiving and communication system (PACS), or any suitable device for storing images and related information.

The signal processor 232 may be one or more central processing units, microprocessors, microcontrollers, etc. For example, the signal processor 232 may be an integrated component, or may be distributed in various locations. In an illustrative embodiment, the signal processor 232 may be able to receive input information from the user input device 230 and/or file 238, generate outputs that may be shown by the display system 234, manipulate the outputs, etc., in response to the input information from the user input device 230. The signal processor 232 may be capable of executing, for example, any of the methods and/or instruction sets discussed herein according to various embodiments.

The ultrasound system 200 may be configured to continuously acquire ultrasound scan data at a frame rate suitable for the imaging situation under consideration. Typical frame rates are in the range of 20 to 120, but can be lower or higher. The acquired ultrasound scan data can be shown on the display system 234 at the same display rate as the frame rate, or slower or faster than the frame rate. The image buffer 236 is included to store processed frames of the acquired ultrasound scan data that are not scheduled for immediate display. Preferably, the image buffer 236 has sufficient capacity to store frames of ultrasound scan data for at least a few minutes. Frames of ultrasound scan data are stored in such a way that they can be easily retrieved therefrom according to their acquisition sequence or time. The image buffer 236 may be embodied in any known data storage medium.

The display system 234 may be any device capable of communicating visual information to users. For example, the display system 234 may include a liquid crystal display, a light emitting diode display, and/or any one or more suitable displays. The display system 234 may be operated to present ultrasound images and/or any suitable information.

The file 238 may be one or more computer-readable memories integrated with and/or communicatively coupled (e.g., via a network) to the ultrasound system 200, such as a Picture Archiving and Communication System (PACS), a server, a hard disk, a floppy disk, a CD, a CD-ROM, a DVD, a compact memory, a flash memory, a random access memory, a read only memory, an electrically erasable and programmable read only memory, and/or any suitable memory. The file 238 may include, for example, a database, a library, an information set, or other memory accessed by the signal processor 232 and/or incorporated into the signal processor 232. For example, the file 238 can temporarily or permanently store data. The file 238 may be capable of storing medical image data, data generated by the signal processor 232, and/or instructions readable by the signal processor 132, etc.

Components of the ultrasound system 200 may be implemented in software, hardware, firmware, etc. Various components of the ultrasound system 200 may be communicatively connected. The components of the ultrasound system 200 may be implemented individually and/or integrated in various forms. For example, the display system 234 and the user input device 230 may be integrated as a touch screen display.

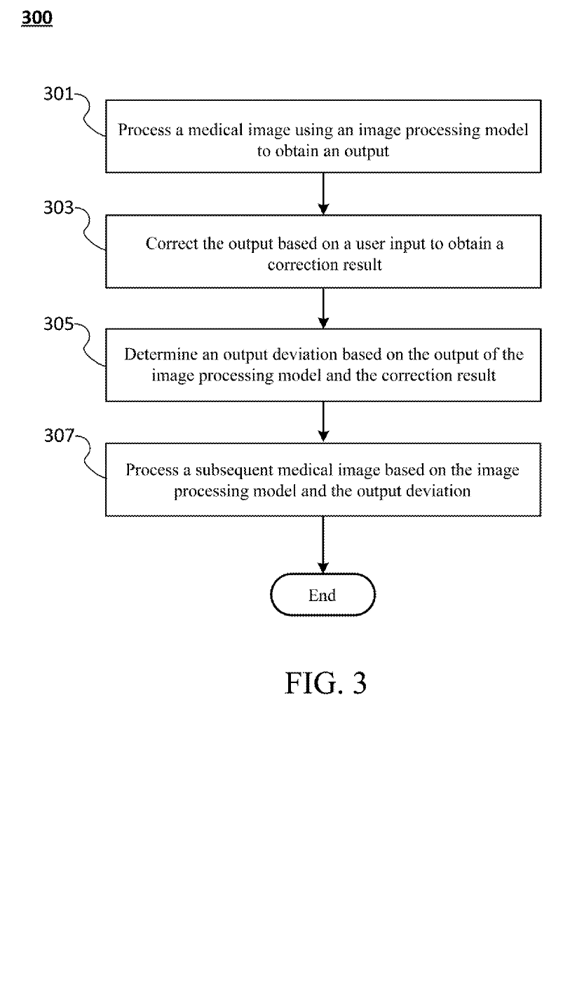

FIG. 3 shows a flowchart of a method 300 for processing a medical image according to some embodiments of the present disclosure. As shown in FIG. 3, the method 300 for processing a medical image may include the following steps S301 to S307.

In step 301, a medical image is processed using an image processing model to obtain an output. The image processing model may be installed in a computing system. The image processing model may generate an output based on workflow. As an example, based on the workflow, various parameters related to examination may be automatically detected and identified without any user input. These parameters may include, for example, parameters related to patient identity, imaging modality used for acquiring images of a patient to be analyzed during examination, and suspected conditions of a patient. The examination workflow may include selecting tool sets and priors to be displayed as part of the examination. The examination workflow may include selection and/or sequencing of action items to be performed to facilitate the examination, and the examination workflow may include which selected pieces of information (for example, priors and references) are to be displayed, where they will be displayed, and formatting of a graphical user interface for presenting diagnostic images and other information during the examination. Further, the computing system can automatically generate a diagnosis workflow. For example, based on the identified parameters, the computing system may automatically select and retrieve the relevant earlier patient scans, as well as the reference images and literature results that are most relevant to the current examination. The computing system may be configured to use artificial intelligence-based models to identify, retrieve, and display prior data that may help clinicians diagnose suspected conditions, thereby reducing the cognitive load for clinicians and also improving diagnostic efficiency. In addition to identifying relevant prior scans and references, the diagnosis workflow may populate the display with the tool set most suitable for the current examination based on the suspected conditions of a patient, imaging modality, and/or clinician. Further, the prior scans and references may be displayed according to an imagine submission protocol selected corresponding to the selected diagnosis workflow.

In some embodiments, one or more image processing models may be trained using artificial intelligence (AI) methods such as machine learning (ML). The one or more image processing models may be configured to perform various processing on images in various application scenarios to obtain results.

FIG. 8 shows an exemplary scenario of use of medical image processing. Taking a scenario where an M-mode sampling line is placed in a medical image as an example, in an actual scenario of use, based on various reasons (for example, different guidelines or different preferences of operators), there may be a plurality of position preferences for placing the M-mode sampling line, and the plurality of positions for placement do not make differences in terms of correctness or superiority. For a user A, an output generated by an algorithm model installed in the medical imaging system may be satisfactory and may be directly used for further analysis. However, a user B and a user C may not be satisfied with the output of the algorithm model, and therefore, the output needs to be further adjusted each time.

In some embodiments, the image processing model may include a model for adding a reference mark to a medical image. For example, the reference mark may include sampling lines as shown in FIG. 8. In some embodiments, the image processing model may include a model for selecting an imaging range in an ultrasound mode. For example, a region of interest (ROI) box may be used to perform blood flow imaging (Color Flow mode/Doppler mode/CW mode/PW mode) on a specific region of the heart (such as a left ventricle or a right ventricle). The ROI box may be used in a vascular ultrasound examination to focus on a specific vascular region to measure a blood flow rate and evaluate a blood flow state. In ultrasound 4D imaging, the ROI box may be used to specify a position where 4D imaging is needed. In some embodiments, the image processing model may include a model for selecting a position for measurement. For example, the image processing model may select the position for measurement based on one of the following user requirements: measurement of the size of a fetal head to assess the growth and development situation thereof; measurement of the wall thickness of a left ventricle or right ventricle to assess cardiac structural functions to determine a cardiac health status; and measurement of the size of a lump in the liver, a kidney, or other organs to aid in diagnosis and monitoring of lesions. In some embodiments, the image processing model may include a model for 2D slice selection based on ultrasound 3D/4D volume data.

In some embodiments, the image processing model may include a first artificial intelligence model. Specifically, the first artificial intelligence model may be learned during an in-factory training process, and may be used to generate an output that conforms to a certain operating standard (for example, clinical diagnosis and treatment guidelines) or preference of a certain user (for example, a user A). In some embodiments, model parameters of the first artificial intelligence model may be set to be constant, that is, after being trained in the factory and leaving the factory, the model parameters of the first artificial intelligence model will not change (in other words, it needs to be frozen so that it cannot be trained) no matter whether the output of the image processing model is adjusted during use. Freezing an artificial intelligence model may be due to consideration from various perspectives. From one perspective, the reason comes from a scenario of strict use of a medical instrument, where an open artificial intelligence model may bring uncertainty and cause potential medical risks. From another perspective, the reason may come from the artificial intelligence model itself: a non-closed artificial intelligence model introduced into hospitals and undergoing long-term uncontrolled training may result in shifted accuracy of the model itself.

In some embodiments, processing the medical image may include: adding an original reference mark to the medical image using the image processing model, where the obtained output may be an output image including the original reference mark. The original reference mark may be directly obtained by processing the image by the first artificial intelligence model, and for example, may include the sampling line that meets preference of user A in FIG. 8.

In step 303, the output obtained in step 301 is corrected based on a user input to obtain a correction result. As described above with reference to FIG. 8, in a case where the output of the image processing model cannot meet the requirements of users (for example, a user B or a user C follows different guidelines or preferences), the users may correct the output of the image processing model to obtain a correction result that meets their requirements. Correcting the output based on the user input may include obtaining a corrected reference mark based on correction made by the user to the original reference mark, and the corrected reference mark may be used as a correction result together with a correction image including the corrected reference mark. For example, in the scenario of use of FIG. 8, the user may adjust the position of the original reference mark obtained by the first artificial intelligence model to obtain the corrected reference mark that meets their preferences and that is displayed in the medical image.

In step 305, an output deviation is determined based on the output of the image processing model obtained in step 301 and the correction result obtained in step 303. The output deviation may be determined based on a parameter difference between the output in step 301 and the correction result obtained in step 303, and may be data that can be used to represent the parameter difference between the output in step 301 and the correction result obtained in step 303, which parameter difference may be associated with the user input or correction in step 303. Specifically, the output deviation may include a difference between a parameter of the original reference mark obtained in step 301 and a parameter of the corrected reference mark obtained in step 303. Preferably, the output deviation may be determined based on the parameter difference using a second artificial intelligence model, and model parameters of the second artificial intelligence model may be set to be constant.

In step 307, a subsequent medical image is processed based on the image processing model and the output deviation determined in step 305. Here, the subsequent medical image refers to a medical image obtained subsequently in an application scenario. In other words, the method described with reference to FIG. 3 may process the medical image based on the output deviation determined in step 305 and combined with both the image processing model and the output deviation determined based on the user input, so as to further adapt to the user preference.

The above configuration allows the output of the artificial intelligence to be adjusted simply and safely even after the artificial intelligence model is frozen and deployed. On the one hand, the accuracy of the subsequent automatic output is ensured. On the other hand, the security of the artificial intelligence model is ensured.

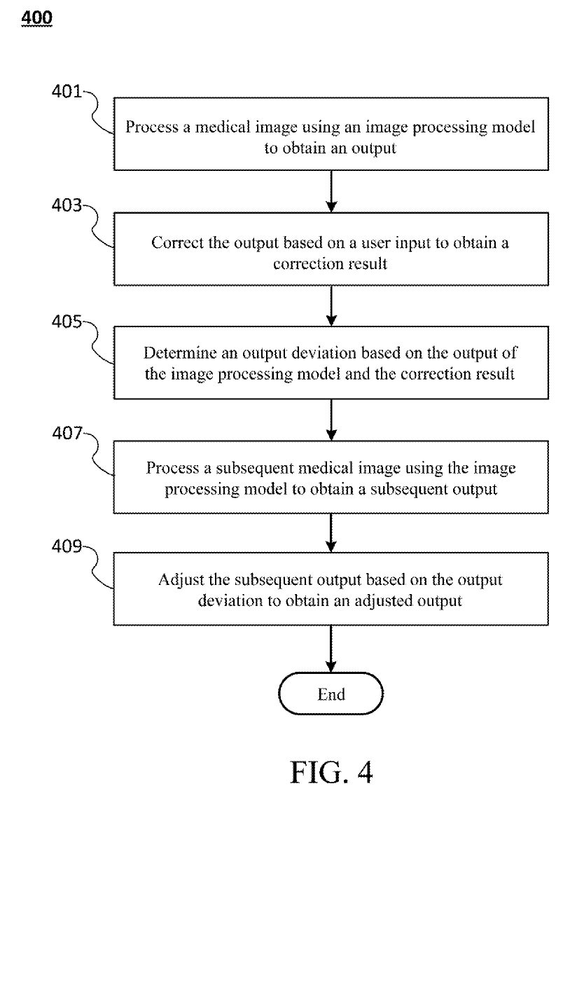

FIG. 4 shows a flowchart 400 of a method for processing a medical image according to some embodiments of the present disclosure. In step 401, a medical image is processed using an image processing model to obtain an output. In step 403, the output obtained in step 401 is corrected based on a user input to obtain a correction result; In step 405, an output deviation is determined based on the output of the image processing model obtained in step 401 and the correction result obtained in step 403. Operations and specific details of step 401 to step 405 are similar to those of step 301 to step 305 described with reference to FIG. 3, and are not described here again.

In step 407, a subsequent medical image is processed using the image processing model to obtain a subsequent output. As previously mentioned, the image processing model includes the first artificial intelligence model having constant model parameters, and the medical image is processed using the image processing model to obtain the output including the original reference mark. In other words, the subsequent output obtained in step 407 is also a subsequent output including the original reference mark obtained from processing by the first artificial intelligence model.

In step 409, the subsequent output obtained in step 407 is adjusted based on the output deviation determined in step 405 to obtain an adjusted output. Thus, after the subsequent medical image is obtained, a correction previously performed by the user is further introduced based on the subsequent output generated by the image processing model, so that the obtained adjusted output is more adapted to the user preference than the subsequent output directly generated by the image processing model.

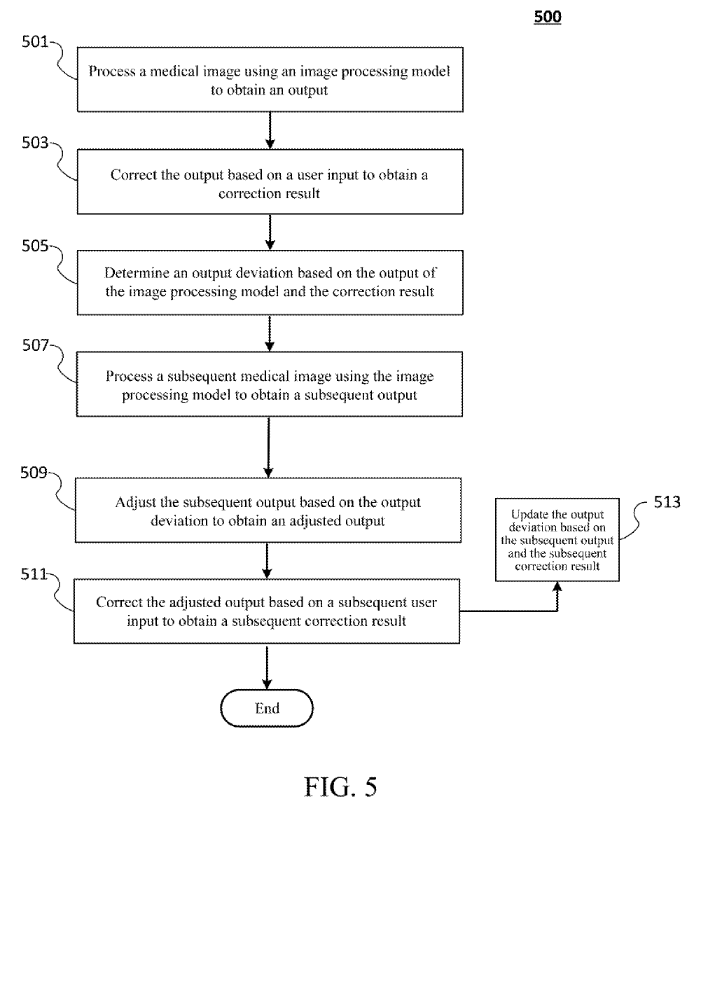

FIG. 5 shows a flowchart 500 of a method for processing a medical image according to another embodiment of the present disclosure. In step 501, a medical image is processed using an image processing model to obtain an output. In step 503, the output obtained in step 501 is corrected based on a user input to obtain a correction result. In step 505, an output deviation is determined based on the output of the image processing model obtained in step 501 and the correction result obtained in step 503. In step 507, a subsequent medical image is processed using the image processing model to obtain a subsequent output. In step 509, the subsequent output generated by the image processing model in step 507 is adjusted based on the output deviation determined in step 505 to obtain an adjusted output. Operations and specific details of step 501 to step 509 are similar to those of step 401 to step 409 described with reference to FIG. 4, and are not described here again.

Since images acquired each time are not completely consistent (for example, there are angular deviations, size deviations and the like), and anatomical features of different patients may have some differences but generally follow a certain similarity, the adjusted output obtained based on the previously determined output deviation in step 509 may not completely match the subsequent medical image, or the previously determined output deviation may still fail to completely meet the user preference when applied to the subsequent medical image. Thus, the user may re-adjust the adjusted output obtained in step 509, and such re-adjustment is set to be the subsequent user input. In step 511, the adjusted output in step 509 is corrected based on a subsequent user input to obtain a subsequent correction result.

In step 513, the output deviation is updated based on the subsequent output obtained in step 507 and the subsequent correction result obtained in step 511. An output more adapted to the user preference can be obtained by further updating the output deviation.

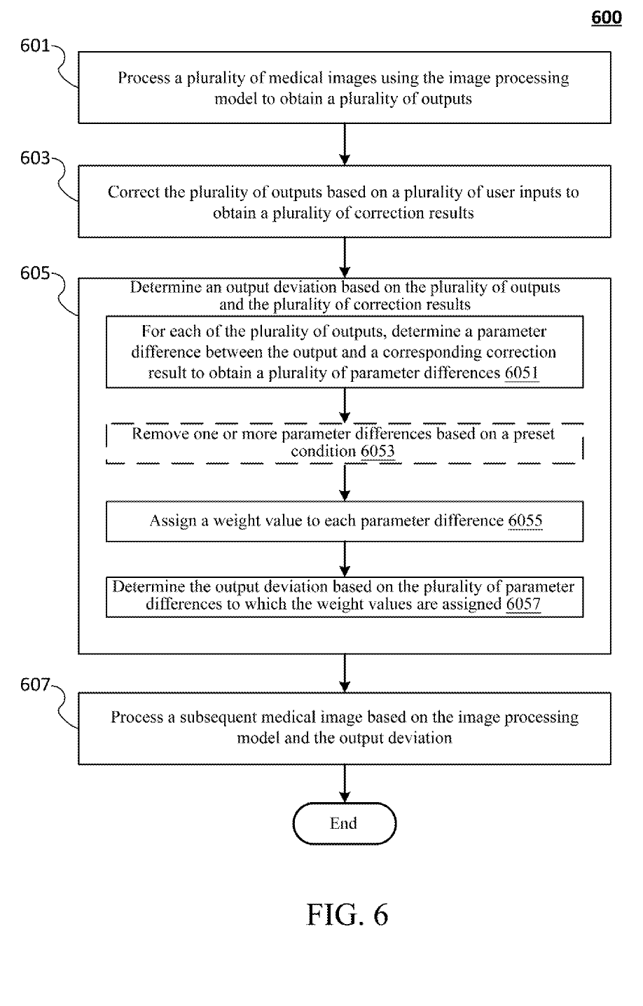

FIG. 6 shows a flowchart 600 of a method for processing a medical image according to some embodiments of the present disclosure. In step 601, a plurality of medical images are processed using the image processing model to obtain a plurality of outputs. In step 603, the plurality of outputs are corrected based on a plurality of user inputs to obtain a plurality of correction results. Operations and specific details of step 601 to step 603 are similar to those of step 301 to step 303 described with reference to FIG. 3, and are not described here again.

In step 605, an output deviation is determined based on the plurality of outputs in step 601 and the plurality of correction results in step 603. Specifically, after each time one medical image is processed using the image processing model to obtain one output, the user corrects the output, and thus the correction result obtained corresponds to the output. In step 6051, for each of the plurality of outputs, a parameter difference between the output and a corresponding correction result is determined to obtain a plurality of parameter differences.

Preferably, in step 6053, one or more parameter differences may be removed based on a preset condition. The preset condition may be preset by a manufacturer during an in-factory training process or by a user during use. As an example, the preset condition may include a range of the parameter difference, but the present disclosure is not limited thereto. For example, a parameter difference that is less than a first value and/or greater than a second value may be defined as an outlier, and thus the outlier may be removed based on such a threshold range.

In step 6055, a weight value may be assigned to each parameter difference; and in step 6057, the output deviation may be determined based on the plurality of parameter differences to which the weight values are assigned. Preferably, the output deviation may be determined based on the parameter difference using a second artificial intelligence model, and model parameters of the second artificial intelligence model may be set to be constant. In other words, in this embodiment, two artificial intelligence models that have been frozen may be used at the same time to implement adaptive adjustment of the output result. Specifically, the first artificial intelligence model is used to provide an initial output, the second artificial intelligence model is used to determine an output deviation according to a plurality of parameter differences, and the two models themselves do not need to be adjusted. This can both ensure safety and dynamically improve output accuracy.

In step 607, a subsequent medical image is processed based on the image processing model and the output deviation.

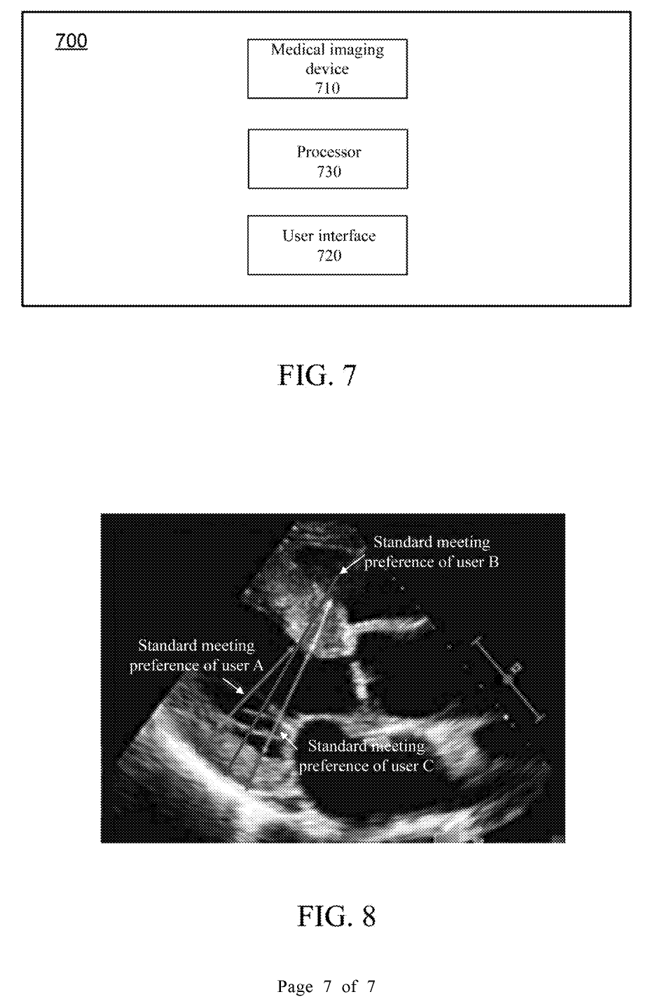

FIG. 7 shows a schematic diagram of a medical imaging system 700 according to some embodiments of the present disclosure. The medical imaging system 700 may include a medical imaging device 710, a user interface 720, and a processor 730. The medical imaging device 710 may be configured to scan a subject to be examined for imaging to acquire a medical image, and in a case where ultrasonic imaging is adopted, the medical imaging device 710 may include an ultrasound probe. The user interface 720 may be configured to receive a user input. The processor 730 may be configured to implement the method for processing a medical image according to various embodiments of the present disclosure, for example, by executing instructions.

As adjustment steps after leaving the factory are introduced in the present disclosure, the image processing method can be automatically adjusted according to the user preference, and user modification suggestions can be learned, thereby improving the satisfaction of users with different preferences or standards regarding image processing. Moreover, the parameters of the artificial intelligence model of the present disclosure may be constant (for example, the weight values of the artificial neural network undergo model-freezing and no longer change), which ensures the safety and controllability of medical diagnosis.

While the present disclosure has been described with reference to certain embodiments, it should be understood by those skilled in the art that various changes may be made and equivalents may be substituted without departing from the scope of the present disclosure. Furthermore, numerous modifications may be made to adapt particular circumstances or materials to the teachings of the present disclosure without departing from the scope thereof. Therefore, the present disclosure is not intended to be limited to the specific embodiments disclosed, but shall encompass all embodiments falling within the scope of the appended claims.

1. A method for processing a medical image, comprising:
processing a medical image using an image processing model to obtain an output;
correcting the output based on a user input to obtain a correction result;
determining an output deviation based on the output and the correction result; and
processing a subsequent medical image based on the image processing model and the output deviation.

2. The method according to claim 1, wherein the processing a subsequent medical image comprises:
processing the subsequent medical image using the image processing model to obtain a subsequent output; and
adjusting the subsequent output based on the output deviation to obtain an adjusted output.

3. The method according to claim 2, further comprising:
correcting the adjusted output based on a subsequent user input to obtain a subsequent correction result; and
updating the output deviation based on the subsequent output and the subsequent correction result.

4. The method according to claim 1, wherein the image processing model comprises a first artificial intelligence model, and model parameters of the first artificial intelligence model are set to be constant.

5. The method according to claim 1, wherein the output deviation is determined based on a parameter difference between the output and the correction result, and the parameter difference is associated with the user input.

6. The method according to claim 5, wherein,
the step of processing a medical image comprises: adding an original reference mark to the medical image using the image processing model, wherein the output comprises an output image, and the output image comprises the original reference mark; and
the correction of the output based on a user input comprises: obtaining a corrected reference mark based on correction to the original reference mark by the user input, wherein the correction result comprises a corrected image, and the corrected image comprises a corrected reference mark; and
the output deviation comprises a difference between a parameter of the original reference mark and a parameter of the corrected reference mark.

7. The method according to claim 1, wherein
the processing a medical image using an image processing model to obtain an output comprises: processing a plurality of medical images using the image processing model to obtain a plurality of outputs;
the correction of the output based on a user input to obtain a correction result comprises: correcting the plurality of outputs based on a plurality of user inputs to obtain a plurality of correction results; and
the determining an output deviation based on the output and the correction result comprises: determining the output deviation based on the plurality of outputs and the plurality of correction results.

8. The method according to claim 7, further comprising:
for each of the plurality of outputs: determining a parameter difference between the output and a corresponding correction result to obtain a plurality of parameter differences; and
assigning a weight value to each of the plurality of parameter differences, wherein the output deviation is determined based on the plurality of parameter differences to which the weight values are assigned.

9. The method according to claim 8, further comprising:
removing one or more of the plurality of parameter differences based on a preset condition.

10. The method according to claim 5, wherein the output deviation is determined based on the parameter differences using a second artificial intelligence model, and model parameters of the second artificial intelligence model are set to be constant.

11. A medical imaging system, comprising:
a medical imaging device, configured to scan a subject to be examined for imaging to acquire a medical image;
a user interface, configured to receive a user input; and
a processor, configured to:
process a medical image using an image processing model to obtain an output;
correct the output based on a user input to obtain a correction result;
determine an output deviation based on the output and the correction result; and
process a subsequent medical image based on the image processing model and the output deviation..

12. The medical imaging system according to claim 11, wherein the medical imaging device comprises an ultrasound probe.

13. A non-transitory computer-readable storage medium, having a computer program stored thereon that, when executed by a computer, causes the computer to:
process a medical image using an image processing model to obtain an output;
correct the output based on a user input to obtain a correction result;
determine an output deviation based on the output and the correction result; and
process a subsequent medical image based on the image processing model and the output deviation.
